(19) United States
(12) Patent Application Publication
(10) Pub. No.: US 2008/0006230 A1
(43) Pub. Date: Jan. 10, 2008

(54) Internal combustion engine variable compression ratio system

(75) Inventors: Mitsuo Kadota, Wako-shi (JP); Kensaku Yamamoto, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/822,744

(22) Filed: Jul. 9, 2007

(30) Foreign Application Priority Data
Jul. 10, 2006 (JP) 2006-189447

(51) Int. Cl. F02B 75/04

(52) U.S. Cl. 123/48 R

(57) ABSTRACT

In an internal combustion engine variable compression ratio system, a compression ratio of an internal combustion engine is changed over between a high compression ratio and a low compression ratio with a changeover threshold value corresponding to a predetermined operational condition of the internal combustion engine being a boundary. When the internal combustion engine enters a slow acceleration state or a slow deceleration state, a changeover is performed first and then the state is maintained for a predetermined period by prohibiting re-changeover. Therefore, changeover hunting can be prevented in the system while maintaining an appropriate compression ratio in conformity with traveling characteristics demanded by a driver, when the internal combustion engine in a state of slow acceleration or slow deceleration.

### BACKGROUND OF THE INVENTION

1. Field of the Invention

The present invention relates to an improvement of an internal combustion engine variable compression ratio system, in which a compression ratio of an internal combustion engine is changed over between a high compression ratio and a low compression ratio with a changeover threshold value corresponding to a predetermined operational condition of the internal combustion engine being a boundary.

2. Description of the Related Art

Japanese Patent Application Laid-open Nos. 2005-54619, 64-15438, 9-228858, and 60-142020 disclose various types of an internal combustion engine variable compression ratio system which enhances combustion efficiency to increase output and reduce fuel consumption by changing over the compression ratio of the internal combustion engine corresponding to the operational condition, while avoiding abnormal combustion such as knocking.

Also, in the variable compression ratio system disclosed in Japanese Patent Application Laid-open No. 64-15438, in the case where changeover hunting is predicted in the system when the system enters a state in which the operational condition of the internal combustion engine frequently crosses the changeover threshold value (mainly caused by load fluctuations), such as in the case of slow acceleration or deceleration, changeover is prohibited for a certain period of time so as to hold the compression ratio before the occurrence of changeover hunting, whereby the durability of the system is secured.

However, the variable compression ratio system which avoids the changeover hunting by prohibiting the changeover for a certain period of time to maintain the compression ratio before the occurrence of changeover hunting when the changeover hunting is predicted as described above, cannot maintain a compression ratio appropriately corresponding to traveling characteristics demanded by the driver. Therefore, improvement in drivability, output, and mileage is not satisfactory.

### SUMMARY OF THE INVENTION

The present invention has been achieved in view of the above circumstances. An object of the present invention is to provide an internal combustion engine variable compression ratio system capable of avoiding changeover hunting in the system while maintaining an appropriate compression ratio in conformity with traveling characteristics demanded by a driver, when an internal combustion engine is in a state of slow acceleration or slow deceleration.

In order to achieve the above object, according to a first feature of the present invention, there is provided an internal combustion engine variable compression ratio system, in which a compression ratio of an internal combustion engine is changed over between a high compression ratio and a low compression ratio with a changeover threshold value corresponding to a predetermined operational condition of the internal combustion engine being a boundary, wherein the system comprises means for holding a changed-over state for a predetermined period of time after a first changeover of compression ratio is performed when the internal combustion engine enters a slow acceleration or deceleration state.

With the first feature of the present invention, when the internal combustion engine enters the slow acceleration or deceleration state, the changeover of compression ratio is performed first and the changed-over state is held for a predetermined period of time, thereby preventing changeover hunting of the system while maintaining the appropriate compression ratio demanded by the driver. Therefore, not only the drivability can be improved, but also an increased engine output and reduced fuel consumption can be achieved, and at the same time, durability of the variable compression ratio system can be enhanced.

According to a second feature of the present invention, in addition to the first feature, the first changeover of compression ratio is performed after changeover approximate time required of the variable compression ratio system has elapsed from the time when the operational condition of the internal combustion engine reaches the changeover threshold value.

With the second feature of the present invention, the compression ratio of the internal compression engine can reliably corresponds to the compression ratio of changeover command.

According to a third feature of the present invention, in addition to the second feature, the predetermined period of time for which a changed-over state is held after the first changeover of compression ratio is performed is set to be residence time or less in the vicinity of the changeover threshold value of the operational condition of the internal combustion engine.

With the third feature of the present invention, after the first changeover of compression ratio, the timing to change the compression ratio over to the next appropriate compression ration cannot be lost.

According to a fourth feature of the present invention, in addition to the third feature, the residence time is calculated based on the operational condition of the internal combustion engine.

With the fourth feature of the present invention, the calculated residence time can be brought as close as possible to the actual residence time by calculating the residence time based on the operational condition of the internal combustion engine.

According to a fifth feature of the present invention, in addition to any of the first to fourth features, the changeover threshold value is set based on at least the throttle opening degree in the internal combustion engine.

With the fifth feature of the present invention, the changeover threshold value can correspond to the torque of the internal combustion engine by calculating the changeover threshold value based on at least the throttle opening degree in the internal combustion engine, and also the accuracy of calculation of the changeover value can be improved.

The above-mentioned object, other objects, characteristics, and advantages of the present invention will become apparent from a preferred embodiment, which will be described in detail below by reference to the attached drawings.

### BRIEF DESCRIPTION OF THE DRAWINGS

FIG. 1 is a longitudinally sectional front view of an essential part of an internal combustion engine provided with a variable compression ratio system according to an embodiment of the present invention.

FIG. 2 is an enlarged sectional view taken along line 2-2 in FIG. 1, showing a high compression ratio state.

FIG. 3 is a view, corresponding to FIG. 2, showing a high compression ratio state.

FIG. 4 is a sectional view taken along line 4-4 in FIG. 2.

FIG. 5 is an enlarged sectional view taken along line 5-5 in FIG. 3.

FIG. 6 is a sectional view taken along line 6-6 in FIG. 2.

FIG. 7 is a sectional view taken along line 7-7 in FIG. 3.

FIGS. 8A to 8D are diagrams for showing an operation of changeover from the high compression ratio state to the low compression ratio state.

FIGS. 9A to 9D are diagrams showing an operation of changeover from the low compression ratio state to the high compression ratio state.

FIG. 10 is a changeover threshold value calculation map provided in an electronic control unit.

FIG. 11 is a changeover approximate time required calculation map provided in the electronic control unit.

FIG. 12 is a changeover threshold value residence time calculation map provided in the electronic control unit.

FIG. 13 is a flowchart showing a procedural sequence of a control program of the electronic control unit.

FIG. 14 is a view for explaining an operation of the electronic control unit.

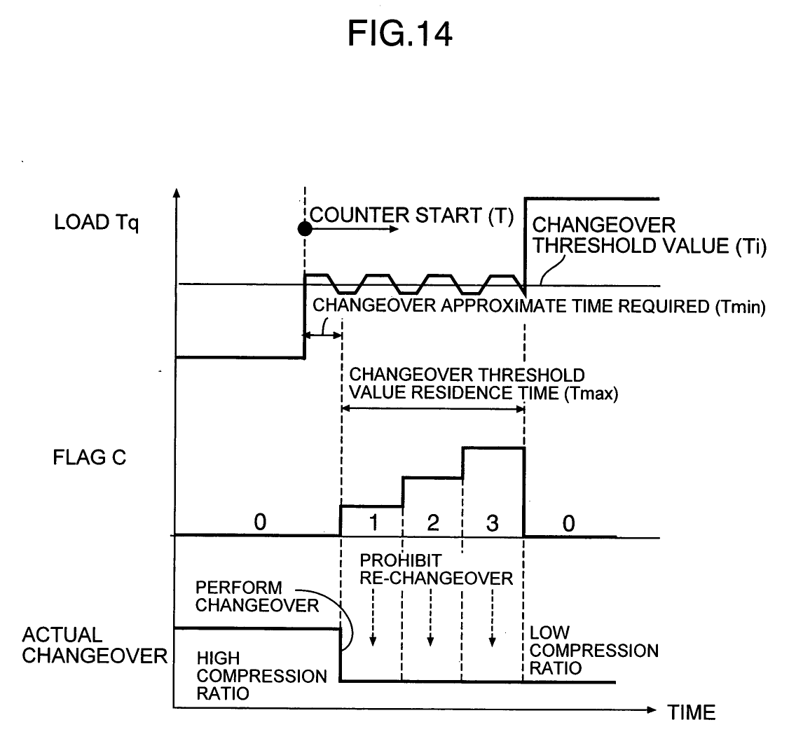

### DESCRIPTION OF THE PREFERRED EMBODIMENT

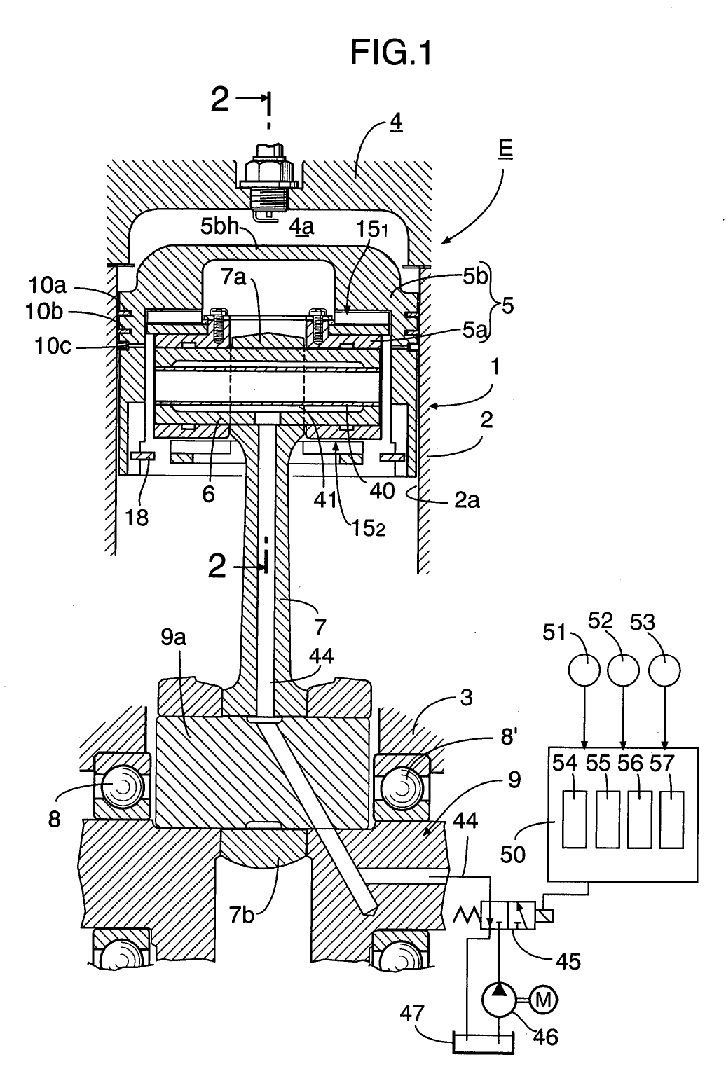

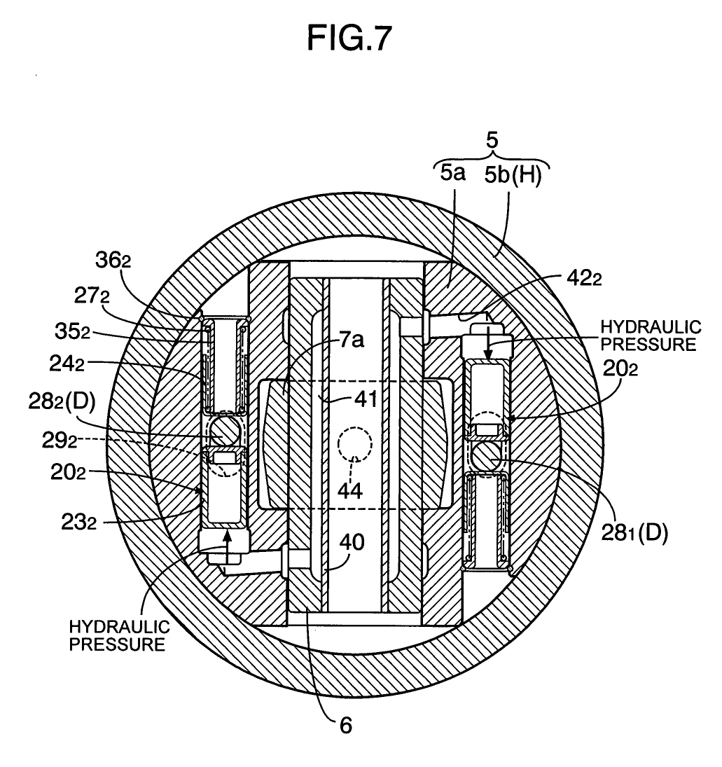

First, the basic structure of a variable compression ratio system of an internal compression engine E is described with reference to FIGS. 1 to 9.

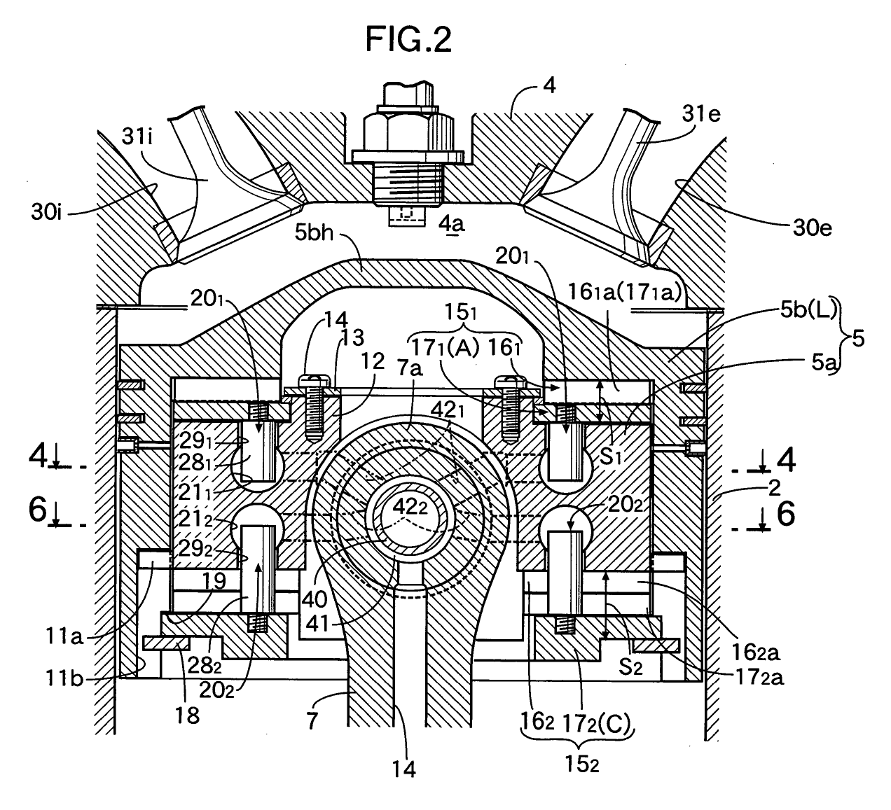

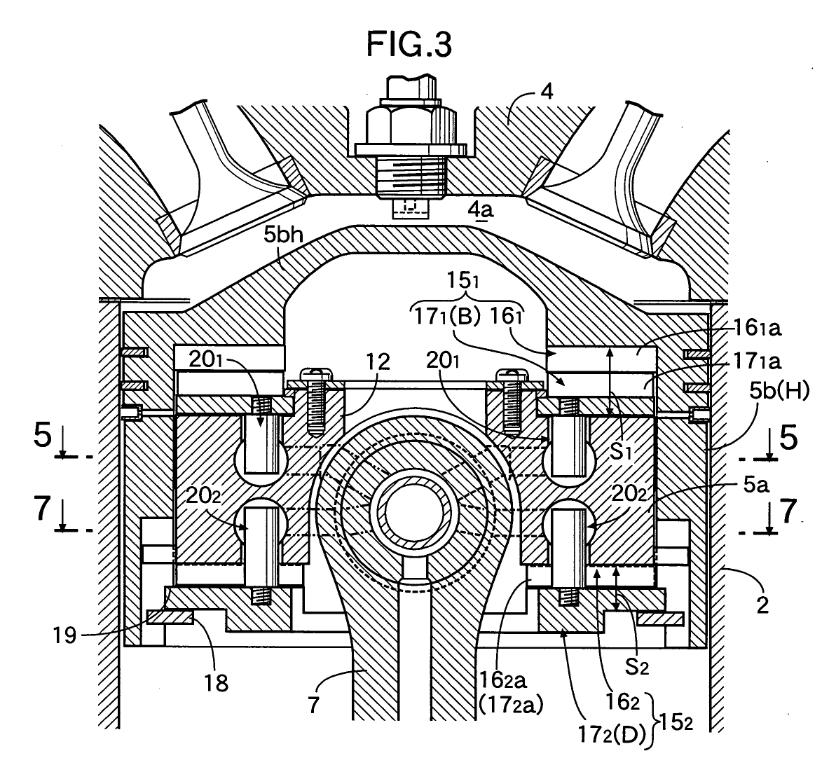

Referring to FIGS. 1 to 3, in the internal compression engine E, a piston 5 moving up and down in a cylinder bore 2a of a cylinder block 2 is connected via a connecting rod 7 to a crankshaft 9 rotatably supported in a crankcase 3 via bearings 8 and 8′. The piston 5 comprises an inner piston 5a and an outer piston 5b. The inner piston 5a is connected to a small end 7a of the connecting rod 7 via a piston pin 6. The outer piston 5b slidably engages with the outer peripheral surface of the inner piston 5a so as to be movable on the inner piston 5a between a predetermined low compression ratio position L (see FIG. 2) and a high compression ratio position H (see FIG. 3). The outer piston 5b slidably engages with the inner peripheral surface of the cylinder bore 2a via a plurality of piston rings 10a to 10c mounted around the outer periphery of the outer piston 5b, and causes a head portion 5bh to face a combustion chamber 4a of a cylinder head 4.

A plurality of spline teeth 11a and spline grooves 11b extending in the axial direction of the piston 5 and engaging with each other are formed on the sliding mating faces of the inner piston and outer 5a and 5b respectively, thereby preventing relative rotation of the inner piston and outer 5a and 5b around their axes. Further, a retaining ring 18 for restricting axial movement of the inner piston 5a relative to the outer piston 5b is latched to an inner peripheral face of the outer piston 5b so that the inner piston 5a is interposed between the retaining ring 18 and, on the opposite side, the head portion 5bh.

A first cam mechanism 15₁ is disposed between the inner piston 5a and the head portion 5bh so as to control a first axial spacing S₁ therebetween, and a second cam mechanism 15₂ is disposed between the inner piston 5a and the retaining ring 18 so as to control a second axial spacing S₂ therebetween. Increasing and decreasing the first and second axial spacings S₁ and S₂ oppositely to each other by means of these first and second cam mechanisms 15₁ and 15₂ enables the outer piston 5b to be held alternately at the low compression ratio position L, which is close to the piston pin relative to the inner piston 5a, and at the high compression ratio position H, which is close to the combustion chamber 4a relative to the inner piston 5a.

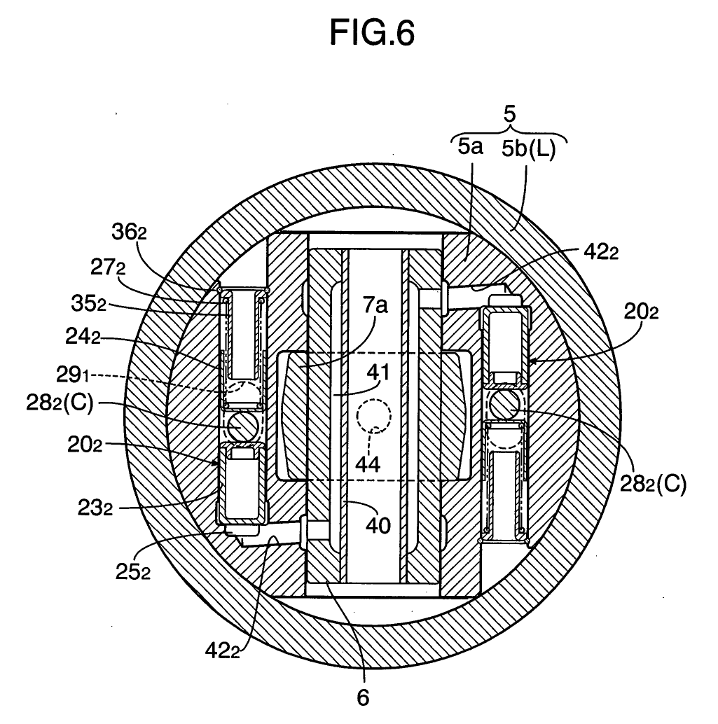

In FIG. 2, FIG. 3, and FIG. 6, the first cam mechanism 15₁ includes an upper first fixed cam 16₁ and a lower first rotating cam plate 17₁ the first fixed cam 16₁ being formed on an inner wall of the head portion 5bh of the outer piston 5b, and the first rotating cam plate 17₁ being supported on an upper face of the inner piston 5a while being pivotably fitted around a pivot portion 12 integrally and projectingly provided on the upper face of the inner piston 5a.

The first rotating cam plate 17₁ is capable of rotating between first and second rotational positions A and B set around the axis thereof, and its reciprocating rotation, in cooperation with the first fixed cam 16₁, increases and decreases the first axial spacing S₁. Specifically, the first fixed cam 16₁ includes a plurality of cam peaks 16₁a arranged in the peripheral direction, and similarly the first rotating cam plate 17₁ is provided integrally with a plurality of cam peaks 17₁a arranged in the peripheral direction.

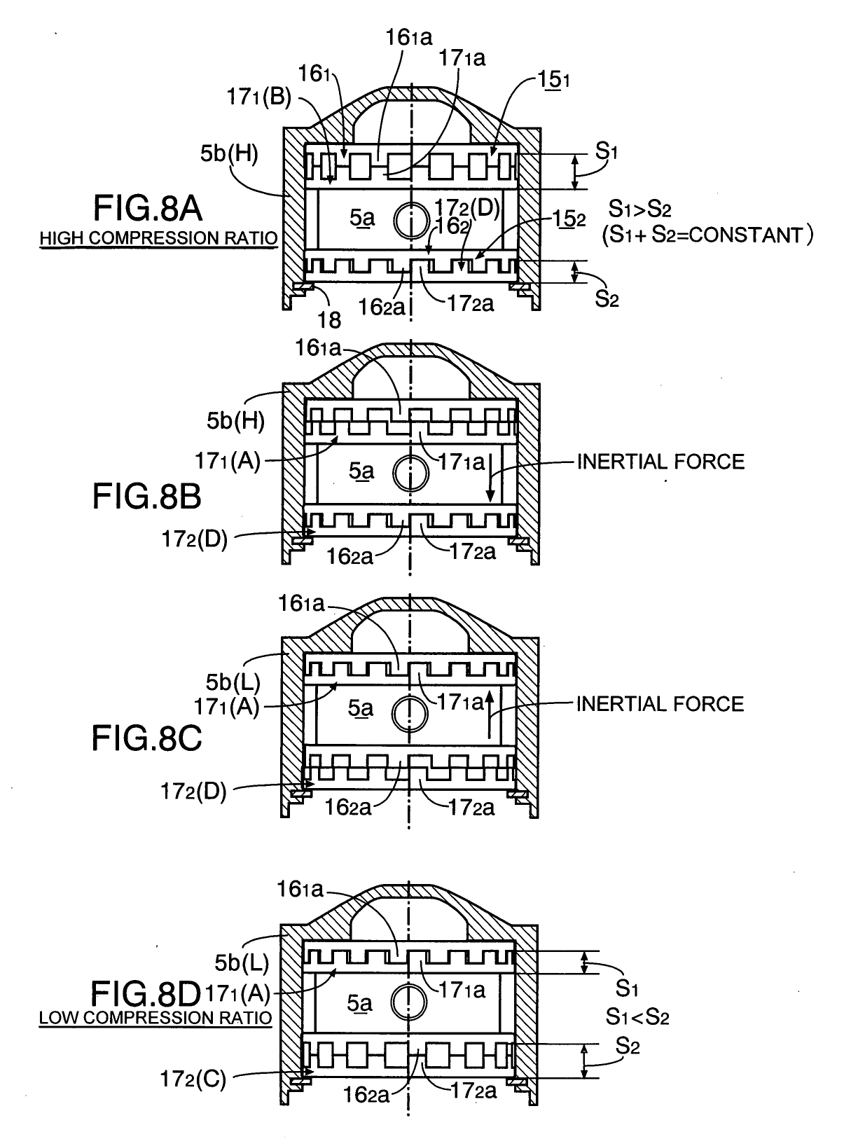

When the first rotating cam plate 17₁ is at the first rotational position A, the cam peak 16₁a of the upper first fixed cam 16₁ can go in and out of a valley between adjacent cam peaks 17₁a of the first rotating cam plate 17₁ (see FIGS. 8A and 8B), and as a result movement of the outer piston 5b to the low compression ratio position L or the high compression ratio position H is allowed. When the upper and lower cam peaks 16₁a and 17₁a mesh with each other, the first cam mechanism 15₁ is in an axially compressed state, thus decreasing the first axial spacing S₁.

On the other hand, when the first rotating cam plate 17₁ is at the second rotational position B, the flat tops of the cam peaks 16₁a and 17₁a of the first fixed cam 16₁ and the first rotating cam plate 17₁ abut against each other (see FIG. 8A), and the first cam mechanism 15₁ is thus in an axially expanded state, thereby increasing the first axial spacing S₁ and holding the outer piston 5b at the high compression ratio position H.

Provided between the inner piston 5a and the first rotating cam plate 17₁ is a first actuator 20₁ for rotating the first rotating cam plate 17₁ alternately to the first rotational position A and the second rotational position B.

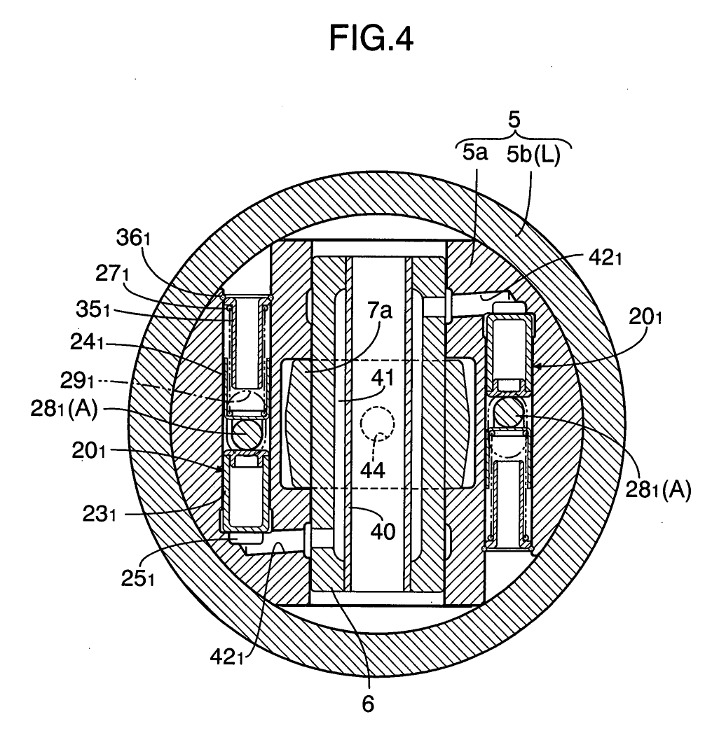

The first actuator 20₁ has a structure as shown in FIG. 2 and FIG. 4. Specifically, the inner piston 5a is provided with a pair of bottomed cylinder holes 21₁ extending parallel to the piston pin 6 on either side thereof, and long holes 29₁ running through an upper wall of a middle section of each of the cylinder holes 21₁. A pair of pressure-receiving pins 28₁ projectingly provided integrally with a lower face of the first rotating cam plate 17₁ and arranged on a diameter thereof run through the long holes 29₁, face the cylinder holes 21₁. The long holes 29₁ are arranged so that the pressure-receiving pins 28₁ are not prevented from moving together with the first rotating cam plate 17₁ between the first rotational position A and the second rotational position B.

An operating plunger 23₁ and a bottomed cylindrical return plunger 24₁ are fitted slidably in each of the cylinder holes 21₁ with the corresponding pressure-receiving pin 28₁ interposed therebetween. In this arrangement, the operating plungers 23₁ and the return plungers 24₁ are each disposed point-symmetrically relative to the axis of the piston 5.

A first hydraulic chamber 25₁ is defined within each of the cylinder holes 21₁, the inner end of the operating plunger 23₁ facing the first hydraulic chamber 25₁. When hydraulic pressure is supplied to the chamber 25₁ the operating plunger 23₁ receives the hydraulic pressure and rotates the first rotating cam plate 17₁ to the second rotational position B via the pressure-receiving pin 28₁.

Moreover, a cylindrical spring retaining tube 35₁ is latched at an end portion on the open side of each of the cylinder holes 21₁ via a retaining ring 36₁, and a return spring 27₁ is provided under compression between the spring retaining tube 35₁ and the return plunger 24₁, the return spring 27₁ urging the return plunger 24₁ toward the pressure-receiving pin 28₁.

In this way, the first rotational position A of the first rotating cam plate 17₁ is defined by each of the pressure-receiving pins 28₁ abutting against the extremity of the operating plunger 23₁, which abuts against the bottom face of the cylinder hole 21₁, and the second rotational position B of the first rotating cam plate 17₁ is defined by the return plunger 24₁, which is pushed by the pressure-receiving pin 28₁, abutting against the extremity of the spring retaining tube 35₁.

In FIG. 2, FIG. 3, and FIG. 6, the second cam mechanism 15₂ includes an upper second fixed cam 16₂ and a lower second rotating cam plate 17₂, the second fixed cam 16₂ being formed on a lower end wall of the inner piston 5a, and the second rotating cam plate 17₂ being rotatably fitted to an inner peripheral face of the outer piston 5b above the retaining ring 18. An annular shoulder 19 is formed on the inner periphery of the outer piston 5b, the shoulder 19 abutting against an upper face of the second rotating cam plate 17₂, and this shoulder 19 and the retaining ring 18 hold the second rotating cam plate 17₂ so that it can rotate but is prevented from axially moving relative to the outer piston 5b.

The second rotating cam plate 17₂ is capable of rotating between a third rotational position C and a fourth rotational position D set around the axis thereof, and its reciprocating rotation, in cooperation with the second fixed cam 16₂, increases and decreases the second axial spacing S₂. Specifically, the second fixed cam 16₂ includes a plurality of cam peaks 16₂a arranged in the peripheral direction, and similarly the second rotating cam plate 17₂ is integrally provided with a plurality of cam peaks 17₂a arranged in the peripheral direction.

The rotational angle between the third and fourth rotational positions C and D of the second rotating cam plate 17₂ is set so as to be identical to the rotational angle between the first and second rotational positions A and B of the first rotating cam plate 17₁. Furthermore, at least the effective heights of the cam peaks 16₂a and 17₂a of the second fixed cam 16₂ and the second rotating cam plate 17₂ are set so as to be identical to those of the cam peaks 16₁a and 17₁a of the first fixed cam 16₁ and the first rotating cam plate 17₁.

When the second rotating cam plate 17₂ is at the third rotational position C, the flat top faces of the cam peaks 16₂a and 17₂a of the second fixed cam 16₂ and the second rotating cam plate 17₂ abut against each other (see FIG. 8D), so that the second cam mechanism 15₂ is in an axially expanded state, thus increasing the second axial spacing S₂ and holding the outer piston 5b at the low compression ratio position L.

When the second rotating cam plate 17₂ is at the fourth rotational position D, the cam peak 16₂a of the second fixed cam 16₂ can go in and out of a valley between adjacent cam peaks 17₂a of the second rotating cam plate 17₂ (see FIGS. 8A and 8C), and as a result movement of the outer piston 5b to the low compression ratio position L or the high compression ratio position H is allowed. When the upper and lower cam peaks 16₂a and 17₂a mesh with each other, the second cam mechanism 15₂ is in an axially compressed state, thus decreasing the second axial spacing S₂.

Provided between the inner piston 5a and the second rotating cam plate 17₂ is a second actuator 20₂ for rotating the second rotating cam plate 17₂ alternately to the third rotational position C and the fourth rotational position D.

The first actuator 20₂ has a structure as shown in FIG. 2 and FIG. 6. Specifically, the structures of the second actuator 20₂ and the first actuator 20₁ are symmetrical. That is, the inner piston 5a is provided with a pair of bottomed cylinder holes 21₂ extending parallel to the piston pin 6 on either side thereof, and long holes 29₂ running through an upper wall of a middle section of the cylinder holes 21₂. A pair of pressure-receiving pins 28₂ projectingly provided integrally with a lower face of the second rotating cam plate 17₂ and arranged on a diameter thereof run through the long holes 29₂, face the cylinder holes 21₂. The long holes 29₂ are arranged so that the pressure-receiving pins 28₂ are not prevented from moving together with the second rotating cam plate 17₂ between the third rotational position C and the fourth rotational position D.

An operating plunger 23₂ and a bottomed cylindrical return plunger 24₂ are fitted slidably in each of the cylinder holes 21₂ with the corresponding pressure-receiving pin 28₂ interposed therebetween. In this arrangement, the operating plungers 23₂ and the return plungers 24₂ are each disposed point-symmetrically relative to the axis of the piston 5.

A second hydraulic chamber 25₂ is defined within each of the cylinder holes 21₂, the inner end of the operating plunger 23₂ facing the second hydraulic chamber 25₂. When hydraulic pressure is supplied to the chamber 25₂ the operating plunger 23₂ receives the hydraulic pressure and pivots the second rotating cam plate 17₂ to the fourth rotational position D via the pressure-receiving pin 28₂.

Moreover, a cylindrical spring retaining tube 35₂ is latched at an end portion on the open side of each of the cylinder holes 21₂ via a retaining ring 36₂, and a return spring 27₂ is provided under compression between the spring retaining tube 35₂ and the return plunger 24₂, the return spring 27₂ urging the return plunger 24₂ toward the pressure-receiving pin 28₂. In this way, the second actuator 20₂ is structured symmetrically with the first actuator 20₁.

In this way, the third rotational position C of the second rotating cam plate 17₂ is defined by each of the pressure-receiving pins 28₂ abutting against the extremity of the operating plunger 23₂, which abuts against the bottom face of the cylinder hole 21₂, and the fourth rotational position D of the second rotating cam plate 17₂ is defined by the return plunger 24₂, which is pushed by the pressure-receiving pin 28₂, abutting against the extremity of the spring retaining tube 35₂.

In the above-mentioned arrangement, the first rotating cam plate 17₁ and the first actuator 20₁, and the second rotating cam plate 17₂ and the second actuator 20₂ allow the outer piston 5b to move between the low compression ratio position L and the high compression ratio position H by virtue of an external force that makes the inner piston and outer 5a and 5b move toward or away from each other in the axial direction, such as a difference in inertial force between the inner piston 5a and the outer piston 5b, the frictional resistance between the outer piston 5b and the inner face of the cylinder bore 2a, or negative or positive pressure acting on the outer piston 5b from the combustion chamber 4a side.

Referring again to FIG. 1 and FIG. 2, a tubular oil chamber 41 is defined between the piston pin 6 and a sleeve 40 press-fitted in a hollow portion of the piston pin 6, and first and second oil distribution passages 42₁ and 42₂ providing a connection between the oil chamber 41 and the hydraulic chambers 25₁ and 25₂ of the first and second actuators 20₁ and 20₂ are provided across the piston pin 6 and the inner piston 5a. The oil chamber 41 is connected to an oil passage 44 that is provided across the piston pin 6, the connecting rod 7, and the crankshaft 9, and this oil passage 44 is switchably connected, via a solenoid control valve 45, to an oil pump 46, which is a hydraulic source, and to an oil reservoir 47.

Switching From High Compression Ratio Position To Low Compression Ratio Position

Assume that, as shown in FIG. 8A, the outer piston 5b is held at the high compression ratio position H. That is, in the first cam mechanism 15₁ the upper and lower cam peaks 16₁a and 17₁a are in the axially expanded state in which top faces thereof are facing each other, and in the second cam mechanism 15₂ the upper and lower cam peaks 16₂a and 17₂a are in the axially compressed state in which they are meshed with each other.

In this state, if the solenoid control valve 45 is put in a non-energized state as shown in FIG. 1 to open the oil passage 44 to the oil reservoir 47, the hydraulic chambers 25₁ and 25₂ of the first and second actuators 20₁ and 20₂ are both opened to the oil reservoir 47 via the oil chamber 41 and the oil passage 44. Therefore, in the first actuator 20₁ the return plunger 24₁ pushes the pressure-receiving pin 28₁ by virtue of the urging force of the return spring 27₁ so as to rotate the first rotating cam plate 17₁ to the first rotational position A; and in the second actuator 20₁ the return plunger 24₂ pushes the pressure-receiving pin 28₂ by virtue of the urging force of the return spring 27₂ so as to rotate the second rotating cam plate 17₂ to the third rotational position C.

When the piston 5 proceeds to the intake stroke, a downward inertial force acts on the inner piston 5a prior to acting on the outer piston 5b, and thus the first cam mechanism 15₁ is released from the thrust load between the inner piston 5a and the outer piston 5b. Therefore, the first rotating cam plate 17₁ is first quickly rotated to the first rotational position A via the pressure-receiving pin 28₁ by virtue of the urging force of the return spring 27₁ of the first actuator 20₁. As a result, as shown in FIG. 8B, the upper and lower cam peaks 16₁a and 17₁a of the first cam mechanism 15₁ are in a configuration in which they are displaced from each other by half the pitch and can mesh with each other.

Subsequently, when the piston 5 comes to the second half of the compression stroke, an upward inertial force acts on the inner piston 5a prior to acting on the outer piston 5b, so that the outer piston 5b descends relative to the inner piston 5a as shown in FIG. 8C while making the upper and lower cam peaks 16₁a and 17₁a of the first cam mechanism 15₁ mesh with each other, that is, while making the first cam mechanism 15₁ compress in the axial direction, thus occupying the low compression ratio position L.

In this way, when the outer piston 5b descends relative to the inner piston 5a, in the second cam mechanism 15₂ the second rotating cam plate 17₂ descends relative to the second fixed cam 16₂, the upper and lower cam peaks 16₂a and 17₂a are accordingly released from the meshed state, and the second rotating cam plate 17₂ is therefore quickly rotated to the third rotational position C via the pressure-receiving pin 28₂ by virtue of the urging force of the return spring 27₂ of the second actuator 20₂. As a result, as shown in FIG. 8D, the flat top faces of the upper and lower cam peaks 16₂a and 17₂a of the second cam mechanism 15₂ are made to abut against each other. Due to this kind of axial expansion of the second cam mechanism 15₂ the second axial spacing S₂ increases, thereby holding the outer piston 5b at the low compression ratio position L to put the internal combustion engine E in a low compression ratio state.

Switching From Low Compression Ratio Position To High Compression Ratio Position

Subsequently, when the internal combustion engine E is being operated at high speed, the solenoid control valve 45 is put in an energized state, thus connecting the oil passage 44 to the oil pump 46. Since hydraulic pressure discharged from the oil pump 46 is supplied to all the hydraulic chambers 25₁ and 25₂ via the oil passage 44 and the oil chamber 41, in the first actuator 20₁ the operating plunger 23₁ receives the hydraulic pressure from the first hydraulic chamber 25₁ and attempts to rotate the first rotating cam plate 17₁ toward the second rotational position B via the pressure-receiving pin 28₁; and in the second actuator 20₂ the operating plunger 23₂ receives the hydraulic pressure from the second hydraulic chamber 25₂ and attempts to rotate the second rotating cam plate 17₂ toward the fourth rotational position D via the pressure-receiving pin 28₂.

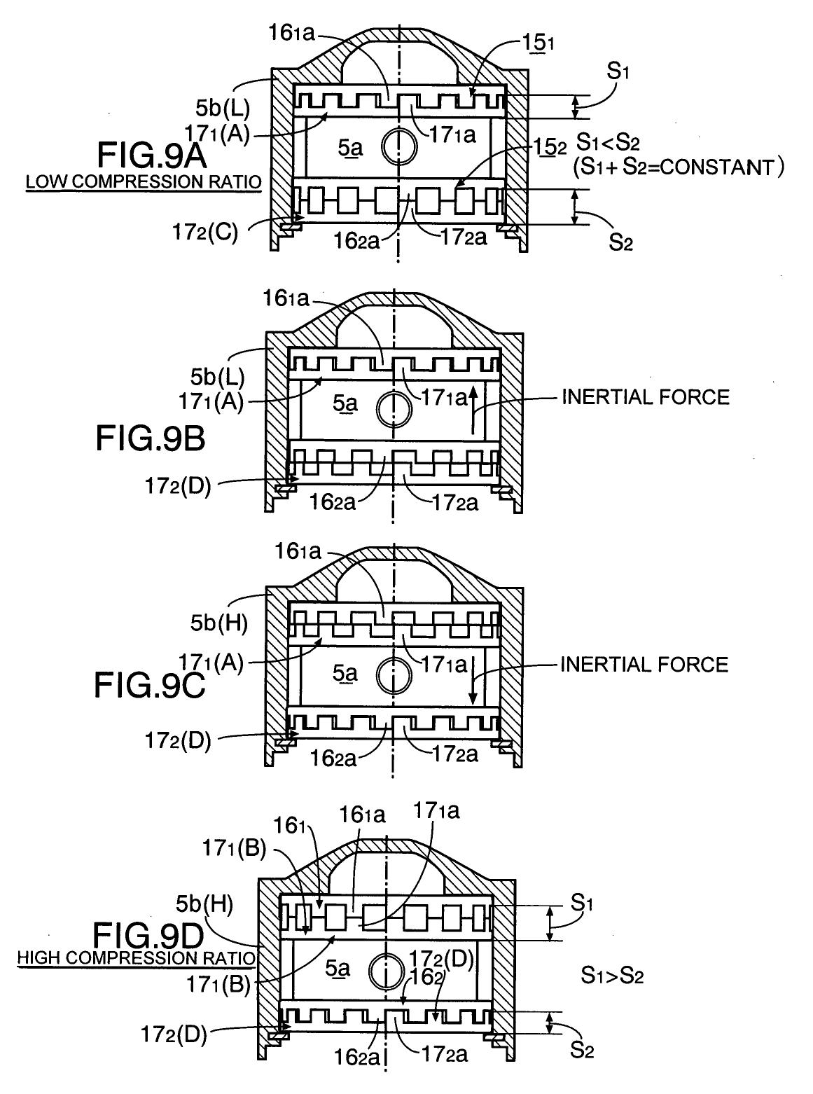

When the piston 5 proceeds to the exhaust stroke, the inner piston 5a receives an upward inertial force before the outer piston 5b receives it, and the second cam mechanism 15₂ disposed between the inner piston 5a and the retaining ring 18 is therefore released from the thrust load. The second rotating cam plate 17₂ is therefore first quickly rotated to the fourth rotational position D via the pressure-receiving pin 28₂ by virtue of the pressing force due to the hydraulic pressure of the operating plunger 23₂ of the second actuator 20₂. As a result, as shown in FIG. 9B, the upper and lower cam peaks 16₂a and 17₂a of the second cam mechanism 15₂ are in a configuration in which they are displaced from each other by half the pitch and can mesh with each other.

Subsequently, when the piston 5 reaches the second half of the intake stroke, since a downward inertial force acts on the inner piston 5a prior to acting on the outer piston 5b, the outer piston 5b ascends relative to the inner piston 5a as shown in FIG. 9C while making the upper and lower cam peaks 16₂a and 17₂a of the second cam mechanism 15₂ mesh with each other, that is, while making the second cam mechanism 15₂ compress in the axial direction, thus occupying the high compression ratio position H.

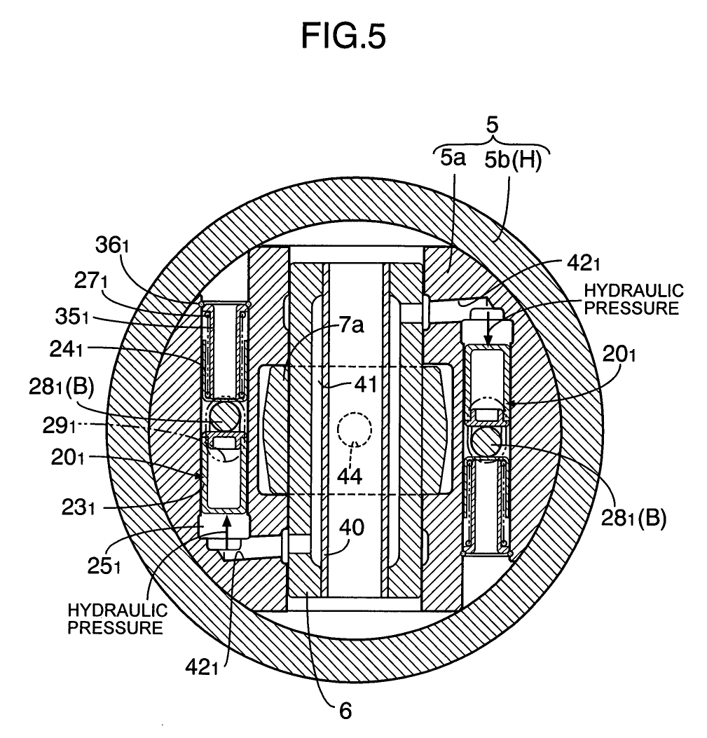

In this way, when the outer piston 5b ascends relative to the inner piston 5a, in the first cam mechanism 15₁ the first fixed cam 16₁ ascends relative to the first rotating cam plate 17₁, the upper and lower cam peaks 16₁a and 17₁a are accordingly released from the meshed state, and the first rotating cam plate 17₁ is therefore quickly rotated to the second rotational position B via the pressure-receiving pin 28₂ by virtue of the pushing force, due to hydraulic pressure, of the operating plunger 23₁ of the first actuator 20₁ (see FIG. 5). As a result, as shown in FIG. 8D, the flat top faces of the upper and lower cam peaks 16₁a and 17₁a of the first cam mechanism 15₁ are made to abut against each other. Due to this kind of axial expansion of the first cam mechanism 15₁, the first axial spacing S₁ increases, thereby holding the outer piston 5b at the high compression ratio position H. Thus, the internal combustion engine E is put in a high compression ratio state.

The structure of the above-described variable compression ration system basically conforms to that of the system disclosed in Japanese Patent Application Laid-open No. 2005-54619.

As shown in FIG. 1, an electronic control unit 50 for controlling the operation to the solenoid switch valve 45 of the solenoid switch valve 45 is connected. Input to the electronic control unit 50 are output signals from components such as a rotational speed sensor 51 for detecting the rotational speed of the engine E, a throttle sensor 52 for detecting the opening of a throttle valve of the engine E, and a temperature sensor 53 for detecting the temperature (for example, the temperature of cooling water) in the engine E.

Provided in the electronic control unit 50 are a changeover threshold value calculation map 54, a changeover approximate time required calculation map 55, a changeover threshold value residence time calculation map 56, and a counter 57 that starts an operation when the operational condition of the engine E enters the region of a changeover threshold value Ti.

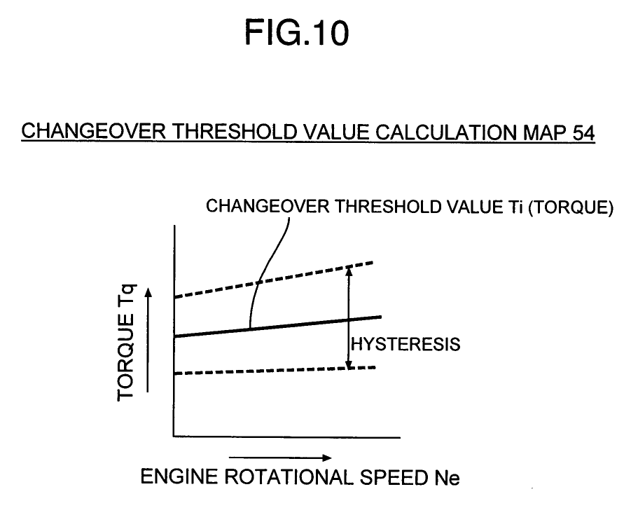

As shown in FIG. 10, according to the changeover threshold value calculation map 54, the changeover threshold value Ti is calculated based on an engine rotational speed Ne and a torque Tq. Because the changeover delay time increases as the engine rotational speed Ne increases, even when the operational condition of the engine E is determined to be in a slow acceleration or deceleration, it is desirable that a hysteresis is added to the calculated value along with the degree of slowness.

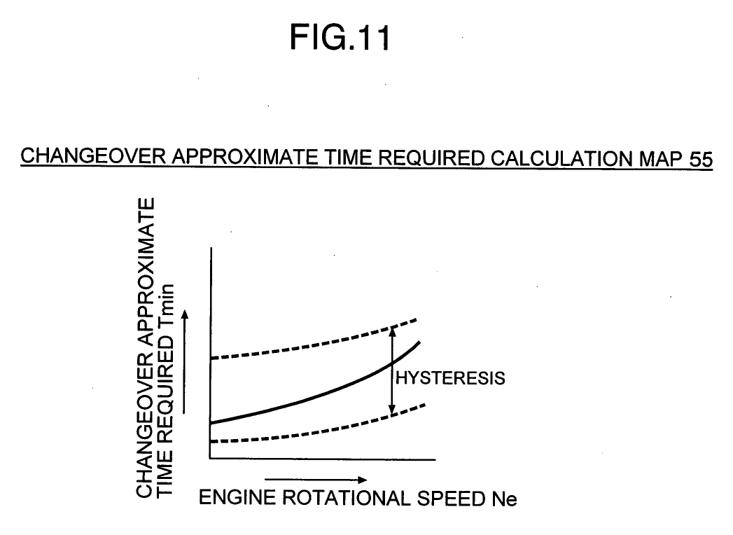

As shown in FIG. 11, according to the changeover approximate time required calculation map 55, changeover approximate time required Tmin is calculated based on the engine rotational speed Ne. In calculating the changeover approximate time required Tmin, it is desirable to consider an engine temperature Tw. That is, when the engine is at a high temperature, the increase in the changeover approximate time required Tmin caused by the decrease in clearances between the components caused by the thermal expansion of the components of the variable compression ratio system is considered. In contrast, when the engine is at a low temperature, the decrease in the changeover approximate time required Tmin caused by the expansion of clearances between the components of the variable compression ratio system is considered.

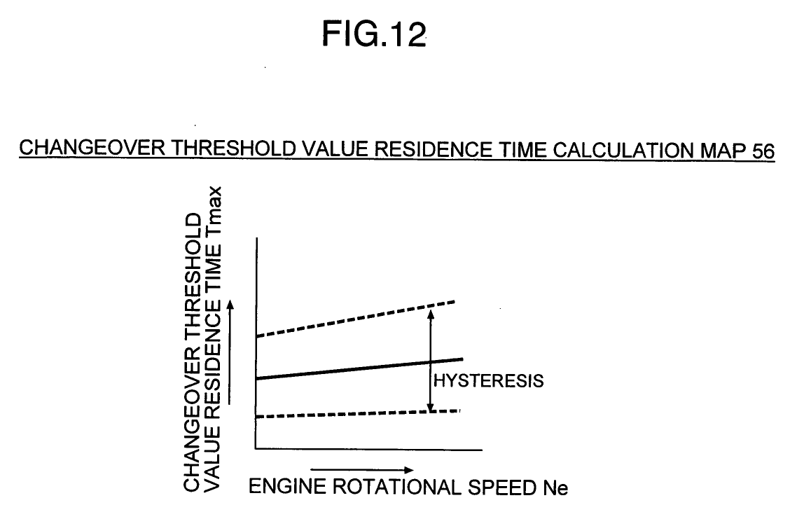

As shown in FIG. 12, according to the changeover threshold value residence time calculation map 56, time Tmax for which the operational condition of the engine E resides in the vicinity of the changeover threshold value Ti is calculated likewise based on the engine rotational speed Ne.

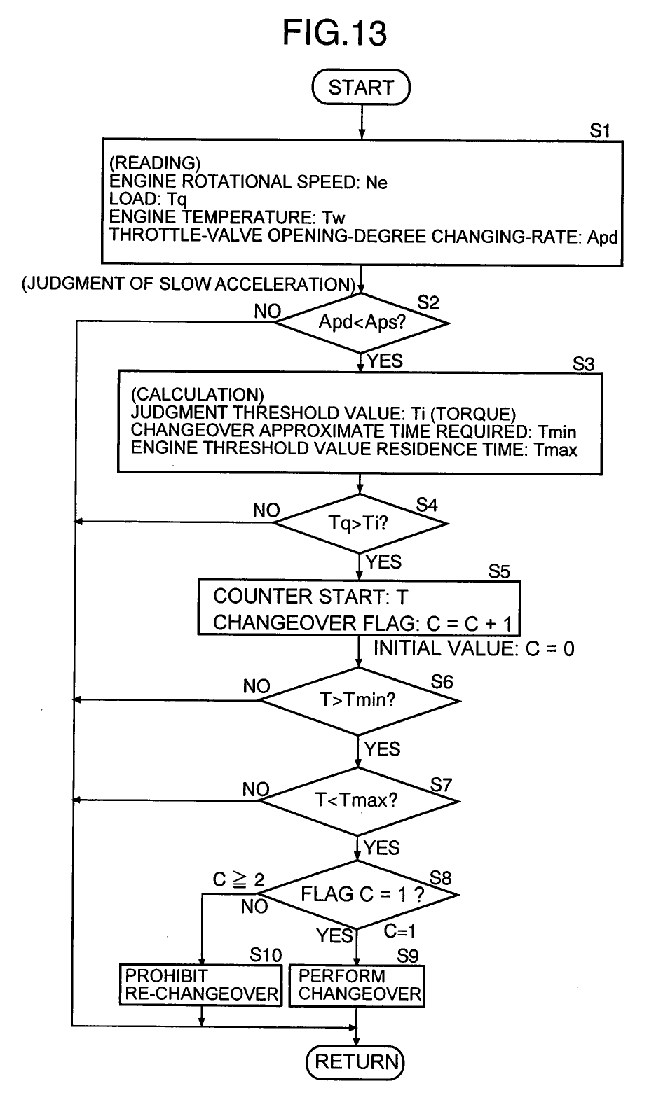

Next, the procedural sequence of the control program for the electronic control unit 50 is described along the flowchart shown in FIG. 13 with reference to the operation diagram of FIG. 12.

First, in Step S1, the engine rotational speed Ne is read from the output signal of the rotational speed sensor 51; the load (torque) Tq of the engine E is read from the output signal of the throttle sensor 52, the change of throttle valve opening degree, namely, the opening degree changing rate Apd of the throttle valve per unit time is read from the output signal of the throttle sensor 52; and the engine temperature Tw is read from the output signal of the temperature sensor 53.

In Step S2, it is judged whether or not the opening degree changing rate Apd of the throttle valve is lower than a predetermined value Aps (the opening degree changing rate of the throttle valve corresponding to the upper limit value of slow acceleration or deceleration) thereby determining whether or not the engine E is in a slow acceleration or deceleration state. If the engine E is in the slow acceleration or deceleration state, the control proceeds to Step S3.

In Step S3, the changeover threshold value Ti is calculated from the changeover threshold value calculation map 54; the changeover approximate time required Tmin is calculated from the changeover approximate time required calculation map 55; and the changeover threshold value residence time Tmax is calculated from the changeover threshold value residence time calculation map 56. Thereafter, the control proceeds to Step S4.

In Step S4, it is judged whether or not the engine torque Tq at this time is larger the changeover threshold value Ti (torque). If the result is YES, the control proceeds to Step S5 assuming that the operational condition of the engine E reaches the changeover threshold value Ti.

In Step S5, the operation of the counter 57 is started immediately, and a changeover flag C is set. Thereafter, the control proceeds to Step S6.

In Step S6, it is judged whether or not the operation time T of the counter 57 is longer than the changeover approximate time required Tmin. If the judgment result is YES, the control proceeds to Step S7.

In Step S7, it is judged whether or not the operation time T of the counter 57 is shorter than the changeover threshold value residence time Tmax. If the result is YES, the control proceeds to Step S8, where it is judged whether or not the changeover flag C is 1. If C=1, a changeover signal is sent to the solenoid switch valve 45 to perform changeover of compression ratio of the engine E.

Subsequently, with the elapse of time, if it comes to be judged that C≧2 in Step S8, the control proceeds to Step S10 to prohibit the re-changeover of the compression ratio.

If it comes to be determined that the operation time of the counter 57 is longer than the changeover threshold value residence time Tmax in Step S7, the control goes to RETURN. Therefore, the prohibition of re-changeover of compression ratio is lifted.

As is apparent from the above description, according to the execution of the control program of the electronic control unit 50, in the case where the engine E enters the slow acceleration or deceleration state, and the operational condition thereof enters a state in which the operational condition of the engine E frequently crosses the changeover threshold value Ti, the compression ratio of the engine E is first changed over once. However, the re-changeover of compression ratio is thereafter prohibited in order to maintain the changed-over state for a predetermined period of time. Therefore, the compression ratio changed over first can be kept as a compression ratio best suitable for the slow acceleration or deceleration operation of the engine E. Such a changeover and holding control of compression ratio is applied to both the changeover from a high compression ratio to a low compression ratio and the changeover from a low compression ratio to a high compression ratio.

Generally, in the slow acceleration or deceleration of the engine E, the compression ratio has a strong tendency that the operational condition of engine resides in the compression ratio changed over first. This tendency is brought about by the change of the throttle valve opening degree which directly shows the traveling characteristics demanded by the driver. Therefore, the holding of the compression ratio changed over first as a compression ratio best suitable for the slow acceleration or deceleration of the engine E, as described above, conforms to the traveling characteristics demanded by the driver, thereby satisfying the drivability and further contributing to an improvement in output and a reduction in fuel consumption. Also, it is needless to say that the durability of the variable compression ratio system can be improved because changeover hunting is avoided in the system.

Also, the first changeover of compression ratio is performed after the changeover approximate time required Tmin of the variable compression ratio system has elapsed from the time when the operational condition of the internal combustion engine E reaches the changeover threshold value Ti. Therefore, the compression ratio of the engine can reliably correspond to the compression ratio of changeover command.

Further, because the predetermined time, for which the changed-over state is maintained after the first changeover of compression ratio, is set to be shorter than the residence time Tmax in the vicinity of the changeover threshold value Ti of the operational condition of the engine E, it is possible to prevent lost of the timing to change the compression ratio over to the next appropriate compression ratio.

Furthermore, calculating the residence time Tmax based on the operational condition of the internal combustion engine E brings the calculated residence time as close as possible to the actual residence time.

The present invention is not limited to the above-mentioned embodiments, and can be modified in a variety of ways without departing from the subject matter of the present invention. For example, the operating mode of the solenoid switch valve 45 can be the opposite of that of the above-mentioned embodiments. That is, an arrangement is possible in which, when the switch valve 45 is in a non-energized state, the oil passage 44 is connected to the oil pump 46, and when it is in an energized state, the oil passage 44 is connected to the oil reservoir 47. Also, the variable compression ration system of the present invention is applicable to the system disclosed in Japanese Patent Application Laid-open No. 2005-54619 as well as to the systems disclosed in Japanese Patent Application Laid-open Nos. 64-15438, 9-228858 and 60-142020.

What is claimed is:

1. An internal combustion engine variable compression ratio system, in which a compression ratio of an internal combustion engine is changed over between a high compression ratio and a low compression ratio with a changeover threshold value corresponding to a predetermined operational condition of the internal combustion engine being a boundary,
wherein the system comprises means for holding a changed-over state for a predetermined period of time after a first changeover of compression ratio is performed when the internal combustion engine enters a slow acceleration or deceleration state.

2. The internal combustion engine variable compression ratio system according to claim 1, wherein the first changeover of compression ratio is performed after changeover approximate time required of the variable compression ratio system has elapsed from the time when the operational condition of the internal combustion engine reaches the changeover threshold value.

3. The internal combustion engine variable compression ratio system according to claim 2, wherein the predetermined period of time for which a changed-over state is held after the first changeover of compression ratio is performed is set to be residence time or less in the vicinity of the changeover threshold value of the operational condition of the internal combustion engine.

4. The internal combustion engine variable compression ratio system according to claim 3, wherein the residence time is calculated based on the operational condition of the internal combustion engine.

5. The variable compression ratio system for an internal combustion engine according to claim 1, wherein the changeover threshold value is set based on at least the throttle opening of the internal combustion engine.

6. The variable compression ratio system for an internal combustion engine according to claim 2, wherein the changeover threshold value is set based on at least the throttle opening of the internal combustion engine.

7. The variable compression ratio system for an internal combustion engine according to claim 3, wherein the changeover threshold value is set based on at least the throttle opening of the internal combustion engine.

8. The variable compression ratio system for an internal combustion engine according to claim 4, wherein the changeover threshold value is set based on at least the throttle opening of the internal combustion engine.
